(19) United States
(12) Patent Application Publication
(10) Pub. No.: US 2021/0301474 A1
(43) Pub. Date: Sep. 30, 2021

(54) Infill for an Artificial Turf System

(71) Applicant: Celanese International Corporation, Irving, TX (US)

(72) Inventor: Andrea Vivirelli, Forli (IT)

(21) Appl. No.: 17/191,825

(22) Filed: Mar. 4, 2021

Related U.S. Application Data
(60) Provisional application No. 62/994,885, filed on Mar. 26, 2020.

(51) Int. Cl. E01C 13/08; C08L 53/02; C08L 23/10

(52) U.S. Cl. CPC E01C 13/08; C08L 23/10; C08L 53/02

(57) ABSTRACT

An artificial turf system is provided. The turf system comprises an artificial turf carpet comprising synthetic fibers and a plurality of infill granules disposed between the synthetic fibers. The infill granules have a curved shape and a length of about 5 millimeters or more. Further, the granules comprise a polymer composition that includes a polymer matrix, the polymer matrix including at least one thermoplastic elastomer.

### CROSS REFERENCE TO RELATED APPLICATION

The present application claims filing benefit of U.S. Provisional Patent Application Ser. No. 62/994,885 having a filing date of Mar. 26, 2020, which is incorporated herein by reference in its entirety.

### BACKGROUND OF THE INVENTION

Many sports, such as soccer, tennis, and football, are now played on artificial turf sports fields. Artificial turf sports fields generally require less maintenance and can be played on much more intensively than the natural turf sports fields. To give the artificial turf sports field a playing characteristics that resembles a natural turf field, polymer granules are often spread between the artificial turf fibers that not only provide a softer, shock-absorbing playing surface on which players are less prone to injury, but also provide improved playing characteristics. Unfortunately, however, a problem remains in that it is often difficult to maintain the desired shock absorption, energy restitution, and vertical ball rebound properties over an extended period of time. For example, WO 2006/092337 describes a polymer granule that has a cylindrical shape with a length/diameter ratio from 0.8 to 1.2 and having a substantial uniform particle size. However, the use of such polymer granules as infill material in artificial turf structures has a number of drawbacks. During use, for instance, the infill granules can become loose and fly above the turf system surface. This is generally known as “splash” of the infill as the movement of the infill granules resembles the splash of an object hitting a puddle of water. As a result, areas containing little infill may form in places where the field is played on very intensively, such as near the goal of a soccer field. Not only does this inconsistent distribution have an impact on the quality of play, but it can also potentially lead to an increased risk of injury. To maintain consistency, the turf must be routinely inspected and maintained, which is a time-consuming and costly manual process.

As such, a need currently exists for an infill material for use in artificial turf system that is capable of more consistently remaining in place during use.

### SUMMARY OF THE INVENTION

In accordance with one embodiment of the present invention, an artificial turf system is disclosed that comprises an artificial turf carpet comprising synthetic fibers and a plurality of infill granules disposed between the synthetic fibers. The infill granules have a curved shape and a length of about 5 millimeters or more. Further, the granules comprise a polymer composition that includes a polymer matrix, the polymer matrix including at least one thermoplastic elastomer.

In accordance with another embodiment of the present invention, an artificial turf infill is disclosed that comprises a plurality of infill granules. At least 50% of the granules have a curved shape, length of about 5 millimeters or more, and cross-sectional width of from about 1 to about 10 millimeters. Further, the granules comprise a polymer composition having a Shore A hardness of from about 20 to about 100 as determined in accordance with ASTM D2240-15e1, wherein the polymer composition includes a polymer matrix containing at least one thermoplastic elastomer that includes a styrenic block copolymer, vinyl acetate polymer, polyester, polyurethane, polyolefin, natural rubber, nitrile-butadiene copolymer, polyisoprene, butyl rubber, or a combination thereof.

Other features and aspects of the present invention are set forth in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a schematic view of one embodiment of an artificial turf system of the present invention;

FIG. 2 is a schematic view of another embodiment of an artificial turf system of the present invention; and

FIGS. 3-4 are schematic views of one embodiment of an artificial turf infill granule of the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to infill granules for use in an artificial turf system, such as a soccer field, football field, tennis court, field hockey field, rugby field, track, etc. By selectively controlling the particular material and geometry of the granules, the present inventors have discovered that they can be particularly well suited for use as an infill material that is less susceptible to splash during use of the turf system. The granules, for example, are formed to have a curved or bent shape and a relatively large length.

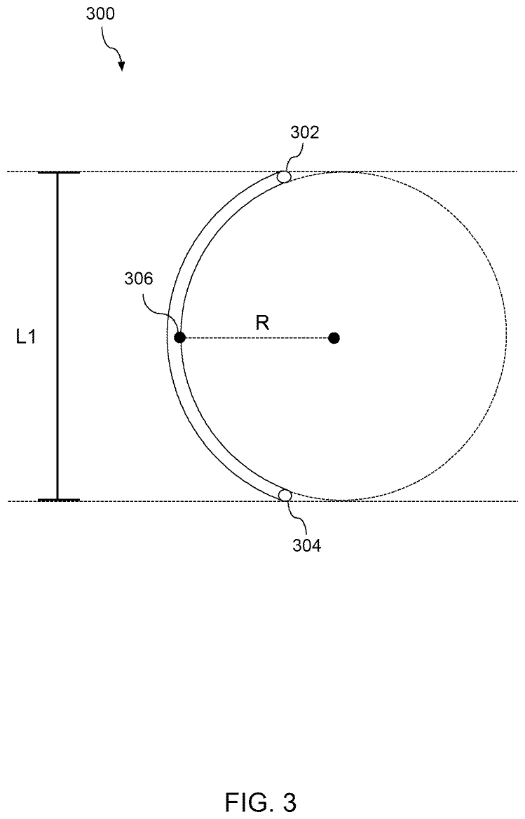

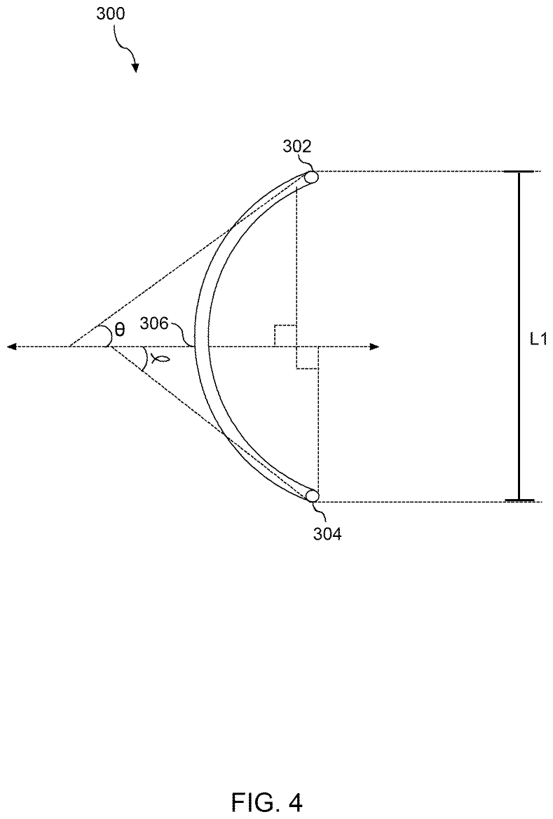

Referring to FIGS. 3-4, for example, one embodiment of such a curved infill granule 300 is shown in more detail. As shown, the granule 300 has a first end 302, a second end 304, and a bending point 306. The length L1 of the granule 300 is defined as the distance extending along the longitudinal axis from the first end 302 to the second end 304, which as noted above, is relatively large and typically in the range of about 5 millimeters or more, in some embodiments from about 5 millimeters to about 30 millimeters, and in some embodiments, from about 5 millimeters to about 20 millimeters. The cross-sectional shape of the granule may vary as desired, such as substantially circular, elliptical, triangular, star-shaped, square, etc. In the illustrated embodiment, for instance, the granule 300 has a circular cross-sectional shape such that the granule itself is generally cylindrical in nature. The cross-sectional width (e.g., diameter) may vary but is typically in the range of about 1 to about 10 millimeters, in some embodiments from about 1.5 to about 5 millimeters, and in some embodiments, from about 2 to about 4 millimeters. The granule may be solid or hollow depending on the properties desired. When a hollow granule is employed, the exterior width (e.g., diameter) may be within the ranged noted above, while the interior width (e.g., diameter) that defines the hollow cavity may be the range of about 0.5 to about 9 millimeters, in some embodiments from about 1 to about 6 millimeters, and in some embodiments, from about 1.5 to about 3 millimeters.

The manner in which the granule is curved may also vary as is known to those skilled in the art. In the illustrated embodiment, for instance, the bending point 306 of the granule 300 is also the midpoint between the two ends 302 and 304. However, this is by no means required and the granule 300 may generally be curved at one or more points along its length. Furthermore, it should also be understood that the granule 300 need not be curved in only one direction as shown in FIGS. 3-4. For example, the granule may be curved in multiple directions at different bending points along its length if so desired. Regardless of the particular bending point and/or direction, the relative “degree of curvature” may be controlled to help minimize the degree of splashing during use. For instance, the granule may have a “degree of curvature” of from about 0.3 mm⁻¹ to about 2 mm⁻¹, such as 0.5 mm⁻¹ to about 1.5 mm⁻¹, such as from about 1.0 mm⁻¹ to about 2 mm⁻¹. The “degree of curvature” may be determined by the well-known osculating circle method as shown in FIG. 3. According to this method, a hypothetical osculating circle may be determined for the curved granule as the circle passing through a certain point (e.g., bending point 306) and has the same tangent and curvature as the curved granule the point (e.g., bending point 306). The degree of curvature of the granule 300 is then determined as the reciprocal of the radius R (1/R) of the osculating circle. The radius “R” may, for example, range from about 0.5 to about 4 millimeters, in some embodiments from about 0.6 to about 3 millimeters, and in some embodiments, from about 1 to about 2 millimeters. As shown in FIG. 4, a horizontal axis also generally divides the granule 300 at the point noted above (e.g., bending point 306). The pellet 300 may thus define a first curvature angle ⊖, formed at the angle between the horizontal axis and the tangent line extending from the first end 302 of the granule 300. In certain embodiments, the first curvature angle ⊖ may range from about 5° to about 85°, in some embodiments from about 10° to about 80°, in some embodiments from 20° to about 70°, in some embodiments from about 35° to about 60°, and in some embodiments, from about 40° to about 50°. The granule 300 may likewise define a second curvature angle α, formed at the angle between the horizontal axis and the tangent line extending from the second end 304 of the granule 300. The second curvature angle α, which may be the same or different than the first curvature angle ⊖, may range from about 5° to about 85°, in some embodiments from about 10° to about 80°, in some embodiments from 20° to about 70°, in some embodiments from about 35° to about 60°, and in some embodiments, from about 40° to about 50°.

In addition to the overall geometry, the material used to form the granules may also be selectively controlled to help achieved the desired infill properties. More particularly, the granules are formed from a polymer composition that includes a thermoplastic elastomer. The polymer composition typically has a Shore A hardness of from about 20 to about 100, in some embodiments from about 30 to about 90, in some embodiments from about 40 to about 85, and in some embodiments, from about 50 to about 80, such as determined in accordance with ASTM D2240-15e1. Suitable thermoplastic elastomers may include, for instance, styrenic block copolymers, vinyl acetate polymers (e.g., ethylene vinyl acetate), polyesters (e.g., copolyetheresters), polyurethanes, polyolefins (e.g., ethylene-propylene copolymers, ethylene-propylene-diene terpolymers, etc.), natural rubbers, nitrile-butadiene copolymers, polyisoprene, butyl rubber (e.g., halogenated butyl rubber), and so forth.

Styrenic block copolymers may, for instance, include one or more monoalkenyl arene blocks (e.g., styrene, methyl styrene, tert-butyl styrene, 1,3 dimethyl styrene, etc.) and one or more conjugated diene blocks (e.g., butadiene, isoprene, pentadiene, hexadiene, or selectively hydrogenated dienes). Particularly suitable styrenic block copolymers include styrene-diene block copolymers (e.g., styrene-butadiene (“SB”), styrene-isoprene (“SI”), styrene-butadiene-styrene (“SBS”), and styrene-isoprene-styrene (“SIS”)) and styrene-olefin block copolymers formed by selective hydrogenation of styrene-diene block copolymers (e.g., styrene-(ethylene-butylene) (“SEB”), styrene-(ethylene-propylene) (“SEP”), styrene-(ethylene-butylene)-styrene (“SEBS”), styrene-(ethylene-propylene)-styrene (“SEPS”), styrene-(ethylene-butylene)-styrene-(ethylene-butylene) (“SEBSEB”), styrene-(ethylene-propylene)-styrene-(ethylene-propylene) (“SEPSEP”), and styrene-ethylene-(ethylene-propylene)-styrene) (“SEEPS”). These block copolymers may have a linear, radial or star-shaped molecular configuration. Likewise, suitable polyolefin elastomers may include ethylene-α-olefin-diene copolymers. The α-olefin constituent of such copolymers may include propylene, 1-butene, 4-methyl-1-pentene, 1-hexene, 1-octene, etc. Propylene is particular suitable such that the resulting copolymer is ethylene-propylene-diene (“EPDM.”). The weight ratio of ethylene to α-olefin may be from about 50:50 to about 90:10, in some embodiments from about 65:35 to about 90:10, and in some embodiments, from about 70:30 to about 85:15. The diene constituent in such copolymers may likewise include 1,4-pentadiene, 1,4-hexadiene, divinylbenzene, dicyclopentadiene, methylenenorbornene, ethylidenenorbornene, vinylnorbornene, etc. (e.g., ethylidenenorbornene). If desired, such copolymer elastomers may also be cured or vulcanized as is known in the art. More particularly, the side chain unsaturation provides for curing by a variety of mechanisms including peroxide, sulfur, and resins.

If desired, other polymers may also be employed in combination with the thermoplastic elastomer(s) in the polymer matrix. Such polymers are generally not elastomeric and may include, for instance, olefin polymers (e.g., ethylene polymers, propylene polymers, etc.), polyamides, polyurethanes, etc. In one embodiment, for instance, a propylene polymer may be employed that has a relatively low melt flow index, such as about 150 grams per 10 minutes or less, in some embodiments about 100 grams per 10 minutes or less, and in some embodiments, from about 1 to about 75 grams per 10 minutes, as determined in accordance with ISO 1133-1:2011 (technically equivalent to ASTM D1238-13) at a load of 2.16 kg and temperature of 230° C. Suitable propylene polymers may include, for instance, propylene homopolymers (e.g., syndiotactic, atactic, isotactic, etc.), propylene copolymers, and so forth. In one embodiment, for instance, a propylene polymer may be employed that is an isotactic or syndiotactic homopolymer. The term “syndiotactic” generally refers to a tacticity in which a substantial portion, if not all, of the methyl groups alternate on opposite sides along the polymer chain. On the other hand, the term “isotactic” generally refers to a tacticity in which a substantial portion, if not all, of the methyl groups are on the same side along the polymer chain. Such homopolymers may have a melting point of from about 160° C. to about 170° C. In yet other embodiments, a copolymer of propylene with an α-olefin monomer may be employed. Specific examples of suitable α-olefin monomers may include ethylene, 1-butene; 3-methyl-1-butene, 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. The propylene content of such copolymers may be from about 60 mole % to about 99 mole %, in some embodiments from about 80 mole % to about 98.5 mole %, and in some embodiments, from about 87 mole % to about 97.5 mole %. The α-olefin content may likewise range from about 1 mole % to about 40 mole %, in some embodiments from about 1.5 mole % to about 15 mole %, and in some embodiments, from about 2.5 mole % to about 13 mole %.

When employed, additional polymer(s) typically constitute from about 5 wt. % to about 50 wt. %, in some embodiments from about 10 wt. % to about 45 wt. %, and some embodiments, from about 20 wt. % to about 40 wt. % of the polymer matrix employed in the polymer composition. Likewise, the thermoplastic elastomer(s) typically constitute from about 50 wt. % to about 95 wt. %, in some embodiments from about 55 wt. % to about 90 wt. %, and in some embodiments, from about 60 wt. % to about 80 wt. % of the polymer matrix. It should also be understood that depending on the type employed, the thermoplastic elastomers may constitute the entire polymer content (100 wt. %) of the composition. Likewise, in certain embodiments, only the polymer matrix is used to form the granule such that the percentages noted above also correspond to the percentages of the entire granule. Of course, various other materials may also be employed in the granule as known in the art, such as fillers (e.g., calcium carbonate, talc, mica, kaolin clay, etc.), plasticizers (e.g., mineral oil, paraffinic oil, aromatic oil, naphthenic oil, etc.), antioxidants, UV-stabilizers, antistatic agents, waxes, foaming agents, lubricants, flame retardants, pigments, and so forth. Plasticizers may, for instance, constitute from about 5 wt. % to about 40 wt. %, in some embodiments from about 10 wt. % to about 35 wt. %, and in some embodiments, from about 15 wt. % to about 30 wt. % of the polymer composition. Fillers may likewise constitute from about 10 wt. % to about 70 wt. %, in some embodiments from about 20 wt. % to about 65 wt. %, and in some embodiments, from about 40 wt. % to about 60 wt. % of the polymer composition. In such embodiments, the polymer matrix may likewise constitute from about 5 wt. % to about 40 wt. %, in some embodiments from about 10 wt. % to about 35 wt. %, and in some embodiments, from about 15 wt. % to about 30 wt. % of the polymer composition.

Generally speaking, a plurality of infill granules are generally employed in the artificial turf system. Desirably, at least a substantial portion of these granules, if not all, are formed in accordance with the present invention. For example, it is typically desired that about 50% or more, in some embodiments about 60% or more, in some embodiments about 70% or more, in some embodiments from about 80% to 100%, in some embodiments from about 90% to 100%, in some embodiments from about 95% to 100%, and in some embodiments, from about 99% to 100% of the granules employed in the turf system have a cross-sectional width, length, degree of curvature, first curvature angle, and/or second curvature angle within the ranges noted above. For example, from about 90% to 100% (e.g., 100%), and in some embodiments, from about 99% to 100% of the granules typically have a length of about 5 millimeters or more, in some embodiments from about 5 millimeters to about 30 millimeters, and in some embodiments, from about 5 millimeters to about 20 millimeters, and/or a cross-sectional width (e.g., diameter) of from about 1 to about 10 millimeters, in some embodiments from about 1.5 to about 5 millimeters, and in some embodiments, from about 2 to about 4 millimeters. Of course, it is contemplated that the granules may have varying properties. In fact, in certain embodiments, varying the degree of curvature and/or curvature angles in different portions of the granules may actually further reduce the likelihood of splashing. For example, in certain embodiments, a first portion of the granules may have a degree of curvature of from about 0.33 mm⁻¹ to about 1 mm⁻¹, in some embodiments from about 0.50 mm⁻¹ to about 1 mm⁻¹, and in some embodiments, from about 0.75 mm⁻¹ to about 1 mm⁻¹, while a second portion of the granules may have a degree of curvature of from about 1.0 mm⁻¹ to about 3 mm⁻¹, in some embodiments from about 1.5 mm⁻¹ to about 2.5 mm⁻¹, and in some embodiments, from about 1.75 mm⁻¹ to about 2 mm⁻¹. The first portion and the second portion may each constitute from about 25% to about 75%, and in some embodiments, from about 35% to about 65% of the granules.

The granules may be formed by any suitable method as is known in the art. For example, the components used to form the granules (e.g., thermoplastic elastomer, additional polymer(s), additive(s), etc.) may be compounded together and then extruded through orifices of a die plate. The size of the orifices are selected based on the desired cross-sectional width (e.g., diameter) of the granules. Once extruded, the resulting granules may then be cut to the desired length through the use of an underwater pelletizing system, water ring pelletizing system, strand pelletizing system, hot-cut pelletizing system, etc. If desired, the strand cutting may occur after the granules are cooled in a water bath or while under water at the face of the die plate. This process is generally known as “underwater pelletizing.” For example, the granules may be extruded through extrusion orifices in the die plate into a water-filled compartment or chamber. While immersed in the water, the granules may then be cut to the desired length by knives mounted on a hub-like member and driven in rotation by a shaft. The cutting edges of the knives lie flat or substantially so against the flat face of the die plate and wipe across the face of the orifices in a cutting or shearing action as the hub is rotated by the shaft.

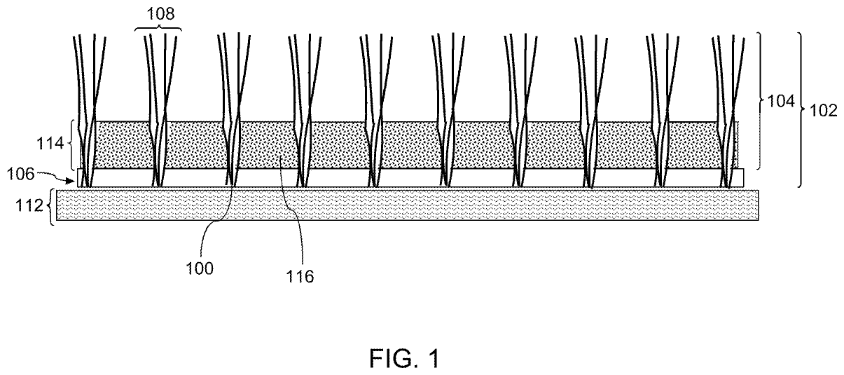

The manner in which the granules are employed in an artificial turf system may vary as is known in the art. Referring to FIG. 1, for example, one embodiment of an artificial turf system 100 is shown that contains an artificial turf carpet 102 having a pile 104. The artificial turf carpet 102 includes a backing 106 within which synthetic fibers 108 are secured and outwardly extend therefrom. The synthetic fibers 108 may be tufted 110 into the backing 106. The pile 104, therefore, is generally formed by the synthetic fibers 108. The synthetic fibers 108 may be formed of a thermoplastic yarn or artificial grass materials as known in the art. The backing 106 may include a backing sheet formed from a sheet of plastic material such as, for example, a non-woven fabric, which is impregnated with an elastomeric material. The backing 106 may be placed onto a base layer 112. In one example, the base layer 112 may be simply be the ground, or it may contain different components for providing drainage and/or absorption of shock from athletes or other users of the artificial turf system 100. Regardless of the particular configuration, an infill layer 114 may be provided that includes a plurality of infill granules 116, which may be formed in accordance with the present invention. The granules 116 are disposed within the pile 104 and between the synthetic fibers 108. The total thickness of the infill layer 114 may vary but is typically from about 5 to about 30 millimeters, and in some embodiments, from about 10 to about 25 millimeters.

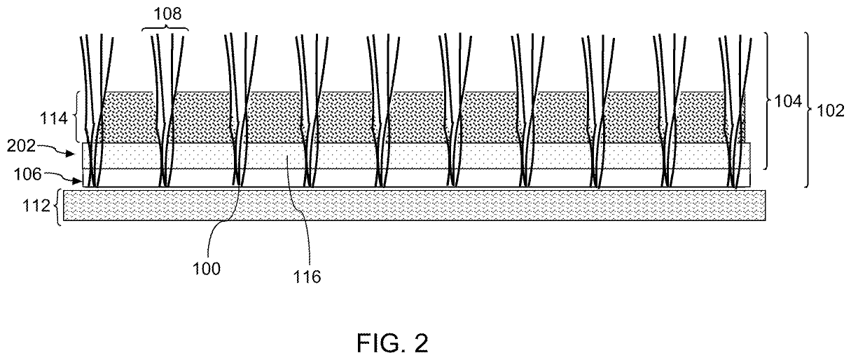

FIG. 2 shows a further example of an artificial turf system 200 that may employ infill granules of the present invention. The artificial turf system 200 is similar to the artificial turf system 100 of FIG. 1 except that an additional layer of sand 202 is disposed between the backing 106 and the infill layer 114.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. An artificial turf system comprising:
an artificial turf carpet comprising synthetic fibers; and
a plurality of infill granules disposed between the synthetic fibers, wherein the infill granules have a curved shape and a length of about 5 millimeters or more, and further wherein the granules comprise a polymer composition that includes a polymer matrix, the polymer matrix including at least one thermoplastic elastomer.

2. The artificial turf system of claim 1, wherein the infill granules have a substantially circular cross-sectional shape.

3. The artificial turf system of claim 1, wherein the infill granules have a cross-sectional width of from about 1 to about 10 millimeters.

4. The artificial turf system of claim 1, wherein the granules have a degree of curvature of from about 0.3 mm⁻¹ to about 2 mm⁻¹.

5. The artificial turf system of claim 1, wherein the polymer composition has a Shore A hardness of from about 20 to about 100 as determined in accordance with ASTM D2240-15e1.

6. The artificial turf system of claim 1, wherein the thermoplastic elastomer includes a styrenic block copolymer, vinyl acetate polymer, polyester, polyurethane, polyolefin, natural rubber, nitrile-butadiene copolymer, polyisoprene, butyl rubber, or a combination thereof.

7. The artificial turf system of claim 1, wherein the thermoplastic elastomer includes a polyolefin.

8. The artificial turf system of claim 7, wherein the polyolefin includes an ethylene-propylene-diene copolymer.

9. The artificial turf system of claim 1, wherein the thermoplastic elastomer includes a styrenic block copolymer.

10. The artificial turf system of claim 9, wherein the styrenic block copolymer includes a styrene-butadiene copolymer, styrene-isoprene copolymer, styrene-butadiene-styrene copolymer, styrene-isoprene-styrene copolymer, styrene-(ethylene-butylene) copolymer, styrene-(ethylene-propylene) copolymer, styrene-(ethylene-butylene)-styrene copolymer, styrene-(ethylene-propylene)-styrene copolymer, styrene-(ethylene-butylene)-styrene-(ethylene-butylene) copolymer, styrene-(ethylene-propylene)-styrene-(ethylene-propylene) copolymer, styrene-ethylene-(ethylene-propylene)-styrene) copolymer, or a combination thereof.

11. The artificial turf system of claim 1, wherein the polymer matrix further includes at least one additional polymer.

12. The artificial turf system of claim 11, wherein the additional polymer includes a polyolefin, polyamide, polyurethane, or a combination thereof.

13. The artificial turf system of claim 11, wherein the additional polymer includes a polyolefin.

14. The artificial turf system of claim 13, wherein the polyolefin contains a propylene polymer having a melt flow index of about 150 grams per 10 minutes or less, as determined in accordance with ISO 1133-1:2011 at a load of 2.16 kg and temperature of 230° C.

15. The artificial turf system of claim 11, wherein the additional polymer constitutes from about 5 wt. % to about 50 wt. % of the polymer matrix and the thermoplastic elastomer constitutes from about 50 wt. % to about 95 wt. % of the polymer matrix.

16. The artificial turf system of claim 1, wherein the polymer composition further includes at least one filler, plasticizer, antioxidant, UV stabilizer, antistatic agent, wax, foaming agent, lubricant, flame retardant, pigment, or a combination thereof.

17. The artificial turf system of claim 1, wherein the polymer composition includes at least one filler in an amount of from about 10 wt. % to about 70 wt. % of the composition and at least one plasticizer in an amount of from about 5 wt. % to about 40 wt. % of the composition, and further wherein the polymer matrix constitutes from about 5 wt. % to about 40 wt. % of the composition.

18. The artificial turf system of claim 1, wherein about 50% or more of the infill granules have a length of about 5 millimeters or more.

19. The artificial turf system of claim 1, wherein about 50% or more of the infill granules have a length of about 5 millimeters or more.

20. The artificial turf system of claim 1, wherein from about 90% to 100% of the infill granules have a length of about 5 millimeters or more.

21. The artificial turf system of claim 1, wherein about 99% to 100% of the infill granules have cross-sectional width of from about 1 to about 10 millimeters.

22. The artificial turf system of claim 1, wherein from about 90% to 100% of the infill granules have a length of about 5 millimeters or more and a cross-sectional width of from about 1 to about 10 millimeters.

23. The artificial turf system of claim 1, wherein from about 99% to 100% of the infill granules have a length of about 5 millimeters or more and a cross-sectional width of from about 1 to about 10 millimeters.

24. The artificial turf system of claim 1, wherein a first portion of the granules have a degree of curvature of from about 0.33 mm⁻¹ to about 1 mm⁻¹ and a second portion of the granules have a degree of curvature of from about 1.0 mm⁻¹ to about 3 mm⁻¹.

25. The artificial turf system of claim 1, wherein the synthetic fibers are secured within a backing and extend outwardly therefrom.

26. The artificial turf system of claim 25, further comprising a sand layer between the backing and the infill granules.

27. A soccer field comprising the artificial turf system of claim 1.

28. Artificial turf infill comprising a plurality of infill granules, wherein at least 50% of the granules have a curved shape, length of about 5 millimeters or more, and cross-sectional width of from about 1 to about 10 millimeters, and further wherein the granules comprise a polymer composition having a Shore A hardness of from about 20 to about 100 as determined in accordance with ASTM D2240-15e1, wherein the polymer composition includes a polymer matrix containing at least one thermoplastic elastomer, wherein the thermoplastic elastomer includes a styrenic block copolymer, vinyl acetate polymer, polyester, polyurethane, polyolefin, natural rubber, nitrile-butadiene copolymer, polyisoprene, butyl rubber, or a combination thereof.

29. Artificial turf infill of claim 28, wherein the infill granules have a substantially circular cross-sectional shape.

30. Artificial turf infill of claim 28, wherein the granules have a degree of curvature of from about 0.3 mm⁻¹ to about 2 mm⁻¹.

31. Artificial turf infill of claim 28, wherein the thermoplastic elastomer includes a polyolefin.

32. Artificial turf infill of claim 31, wherein the polyolefin includes an ethylene-propylene-diene copolymer.

33. Artificial turf infill of claim 28, wherein the thermoplastic elastomer includes a styrenic block copolymer.

34. Artificial turf infill of claim 33, wherein the styrenic block copolymer includes a styrene-butadiene copolymer, styrene-isoprene copolymer, styrene-butadiene-styrene copolymer, styrene-isoprene-styrene copolymer, styrene-(ethylene-butylene) copolymer, styrene-(ethylene-propylene) copolymer, styrene-(ethylene-butylene)-styrene copolymer, styrene-(ethylene-propylene)-styrene copolymer, styrene-(ethylene-butylene)-styrene-(ethylene-butylene) copolymer, styrene-(ethylene-propylene)-styrene-(ethylene-propylene) copolymer, styrene-ethylene-(ethylene-propylene)-styrene) copolymer, or a combination thereof.

35. Artificial turf infill of claim 28, wherein the polymer matrix further includes at least one additional polymer.

36. Artificial turf infill of claim 35, wherein the additional polymer includes a polyolefin, polyamide, polyurethane, or a combination thereof.

37. Artificial turf infill of claim 35, wherein the additional polymer includes a polyolefin.

38. Artificial turf infill of claim 37, wherein the polyolefin includes a propylene polymer having a melt flow index of about 150 grams per 10 minutes or less, as determined in accordance with ISO 1133-1:2011 at a load of 2.16 kg and temperature of 230° C.

39. Artificial turf infill of claim 35, wherein the additional polymer constitutes from about 5 wt. % to about 50 wt. % of the polymer matrix and the thermoplastic elastomer constitutes from about 50 wt. % to about 95 wt. % of the polymer matrix.

40. Artificial turf infill of claim 28, wherein the polymer composition further includes at least one filler, plasticizer, antioxidant, UV stabilizer, antistatic agent, wax, foaming agent, lubricant, flame retardant, pigment, or a combination thereof.

41. Artificial turf infill of claim 28, wherein the polymer composition includes at least one filler in an amount of from about 10 wt. % to about 70 wt. % of the composition and at least one plasticizer in an amount of from about 5 wt. % to about 40 wt. % of the composition, and further wherein the polymer matrix constitutes from about 5 wt. % to about 40 wt. % of the composition.

42. Artificial turf infill of claim 28, wherein from about 90% to 100% of the granules have a length of about 5 millimeters or more and cross-sectional width of from about 1 to about 10 millimeters.

43. Artificial turf infill of claim 28, wherein from about 99% to 100% of the infill granules have a length of about 5 millimeters or more and a cross-sectional width of from about 1 to about 10 millimeters.
